(19) United States
(12) Patent Application Publication
(10) Pub. No.: US 2021/0043026 A1
(43) Pub. Date: Feb. 11, 2021

(54) Common Premise Self-Storage and Retail Facilities Fabrication and Methodology

(71) Applicant: STORAGE IP LLC, Houston, TX (US)

(72) Inventors: David Wayne Ledoux, Houston, TX (US); Richard Waldon Stockton, Jr., Houston, TX (US)

(21) Appl. No.: 16/964,915

(22) PCT Filed: Jan. 28, 2019
(86) PCT No.: PCT/US19/15405

§ 371 Date: Jul. 24, 2020

Related U.S. Application Data
(60) Provisional application No. 62/622,240, filed on Jan. 26, 2018.

(51) Int. Cl. G07F 17/12; G06Q 30/06

(52) U.S. Cl. CPC G07F 17/12; G06Q 30/0645

(57) ABSTRACT

A common premise facility system with: (i) an area of land consisting of ten acres or less; (ii) a retail facility on the area of land; (iii) a rentable storage facility comprising a plurality of shipping containers on the area of land and external from the retail facility; and (iv) wherein each shipping container in the plurality of shipping containers comprises a plurality of doors for accessing respective rentable storage units within a shipping container.

### TECHNICAL FIELD

The preferred embodiments relate to self-storage and retail facilities.

### BACKGROUND ART

Self-storage facilities are increasingly in use in the United States and include a number of associated storage units located at a single location, which may be indoor, outdoor, or a combination thereof and also may include climate control. A typical self-storage facility may have a single story (or level) or multiple stories/levels, where the foundation, and levels above the ground floor if multilevel, have heretofore required substantial infrastructure support, including for example considerable volume (and associated expense) of metal and concrete. In such a facility, its owner/manager typically rents or leases individual storage units to customers, and those units may vary in size, configuration, and are often priced accordingly. The lessee or user of a unit is then able to store and retrieve various items within their unit and access them over typically flexible times during the period of the rental agreement, subject to any additional limitations of the agreement.

Consumers typically avail of self-storage for excess storage area capacity beyond that otherwise available to them. For example, home, apailinent, or other residential dwellers may have limited or inconvenient excess space at their place of residence for storage of personal, business, or other items, so often such a consumer will augment that space by renting a unit in a self-storage facility. Business owners also may likewise rent in a self-storage facility, so as to provide additional capacity beyond that provided by their office space/warehousing.

The preferred embodiments seek to address these and other considerations, as further discussed below.

### DISCLOSURE OF INVENTION

In one preferred embodiment, there is a common premise facility system. The facility system comprises: (i) an area of land consisting of ten acres or less; (ii) a retail facility on the area of land; (iii) a rentable storage facility comprising a plurality of shipping containers on the area of land and external from the retail facility; and (iv) wherein each shipping container in the plurality of shipping containers comprises a plurality of doors for accessing respective rentable storage units within a shipping container.

Other aspects are also described and claimed.

### BRIEF DESCRIPTION OF DRAWINGS

FIG. 1 illustrates a plan view of a preferred embodiment common premise facility system 100, which by way of introduction may be implemented in connection with certain areas of typical retail space.

FIG. 2 illustrates a perspective view of a preferred embodiment implementation of rentable storage facility RSF1 from FIG. 1.

FIG. 3A illustrates a side cross-sectional view of a prior art shipping container corrugated wall relative to the container flooring.

FIG. 3B illustrates a side cross-sectional view of a roll up door installed in line with a cutaway wall of a shipping container per a preferred embodiment.

FIG. 3C illustrates a side cross-sectional view of a preferred embodiment shipping container corrugated wall relative to the container flooring.

FIG. 4 illustrates a pair of corner blocks securely fastened to one another (to join respective containers).

FIG. 5 illustrates a bridge-fitting apparatus with a threaded member that is threadably mated into receiving threads on two different hooks.

FIG. 6 illustrates an alternative fastener for use within the interior of two adjacent corner blocks.

FIG. 7 illustrates alternative roof orientations.

### DESCRIPTION OF EMBODIMENTS

While the above is well-established and has served various types of consumers, the present inventors seek to improve upon the prior art. For example, preferred embodiment aspects are expected to greatly improve certain consumer experiences, relative to various retail space purchases (e.g., home construction and improvement retailers), particularly those consumers who frequent a same retail store on a recurrent basis. Preferred embodiments provide such consumers improved self-storage access, resource allocation, task and stress management, time expenditures, and the like, associated with their own habits and/or business operation. Moreover, preferred embodiment implementations detailed herein of self-storage is achieved efficiently and in part with a goal toward benefits in “green” ecologic measures, including shortening the travel of consumers, implementation of storage structures with less steel and concrete as compared to traditional facilities, and re-purposing of excess shipping containers by modifications thereto. Moreover, the most prolific retailers in the home construction and improvement arenas typically place considerable value on customer experience, convenience and service, community support, and one-stop shopping experience; preferred embodiments may serve any one or more of such goals, while also providing greater loyalty and revenue to the retail establishment. Preferred embodiments providing such improvements are further explored below.

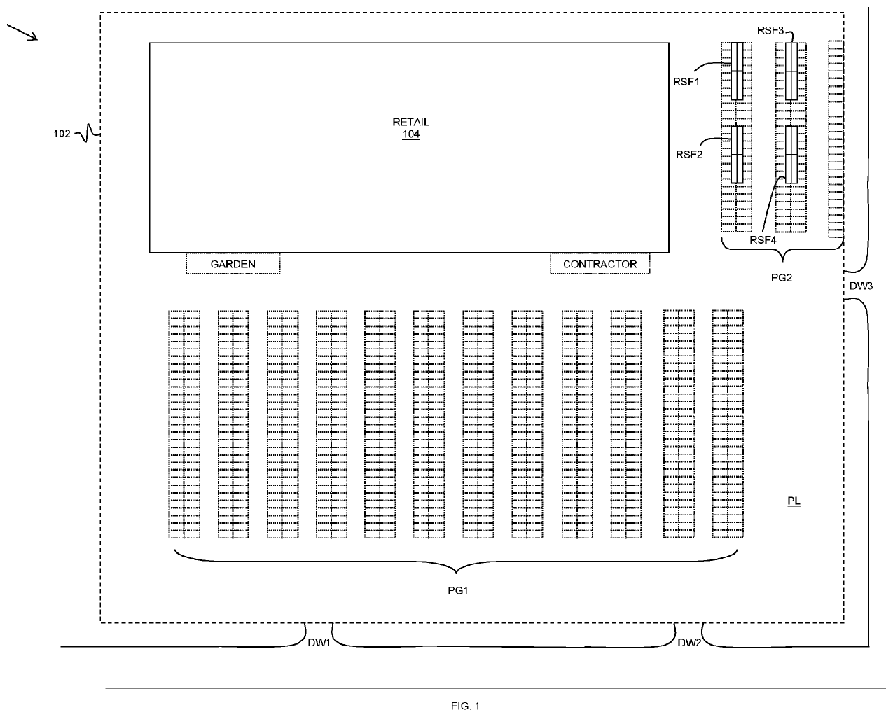

FIG. 1 illustrates a plan view of a preferred embodiment common premise facility system 100, which by way of introduction may be implemented in connection with certain areas of typical retail space. Thus, system 100 includes various aspects known in the art, which are first introduced followed by additional modifications consistent with providing a new and inventive preferred embodiment system. Looking first to known aspects, system 100 has a perimeter 102, which may be a land boundary or plat, as defined by a legal description, deed ownership, or lease of the proprietor of the related facility. Such a boundary has a size typically dictated by various considerations, where for certain large retailers may be in the range of 4 to 10 acres. Within perimeter 102 is located a retail facility 104 as well as various parking locations of a parking lot PL, where in FIG. 1 such parking locations are shown as a parking group PG1 and a parking group PG2, with each parking group containing a number of parking spots as generally indicated by lines in parking areas adjacent retail facility 104; thus, in FIG. 1, parking group PG1 may be considered generally in front of facility 104, while parking group PG2 may be considered generally to a side (right, from the perspective of FIG. 1) of facility 104. The number and orientation of any such parking group may be determined by one skilled in the art based on various considerations. Also in connection with system 100 are driveways DW1, DW2, and DW3, providing manners of ingress/egress relative to system 100, and providing traffic pathways between system 100 and adjacent roadways. Lastly, depending on the goods and/or services offered in retail facility 104, also associated therewith may be specialty areas located relative to the physical spaced defined by the facility. For example, in connection with certain preferred embodiments, it is contemplated that facility 104 sells and/or rents construction, hardware, tools, and related materials, so by ways of examples a particular GARDEN area and a particular CONTRACTOR area are designated relative to facility 104, where each may better serve consumers seeking more immediate access to the goods/services and entrance/exits associated with those areas.

In a preferred embodiment aspect of system 100, also within perimeter 102 and thus common to the premises of retail facility 104, but external from that retail facility 104, are located one or more rentable storage facilities RSF1 through RSF4. Thus, given the general area of perimeter 102, preferably each rentable storage facility is within 500 feet of retail facility 104. Each of rentable storage facilities RSF1 through RSF4 comprises a plural number of modular units, and each modular unit provides one or more rentable storage units (e.g., four as shown in examples herein), for example so that consumers of retail facility 104 (or others) can store items within their respective ones of the rentable storage units, conditioned on such consumers meeting certain terms and conditions as described later. Thus, as illustrated in one preferred embodiment, facilities RSF1 through RSF4 are located among the parking spaces otherwise available in parking group PG2. Accordingly, system 100 provides a basis by which a consumer of the goods/services of retail facility 104 also may very conveniently and efficiently have access to a rentable storage unit with any of rentable storage facilities RSF1 through RSF4. It is contemplated in this regard that consumers will be more readily attracted to the retail experience of system 100, being able to not only shop for goods/services at facility 104, but also to store their own goods and items, whether purchased from retail facility 104, related thereto, or independent thereof, immediately proximate their shopping experience at the retail facility. For example, it is readily common for certain retailers of building supplies to see repeat consumers, particularly of those in the residential and commercial construction and repair businesses, where such consumers often have their own distant facilities and make repeated trips to the retail facility over a period of time for additional supplies. Often consumers of this sort must have distant other sites, including their own commercial office and/or warehouse, where they are required to periodically travel, so as to access and/or store surplus materials, tools, equipment, and other supplies. Moreover, such trips are sometimes only permitted for certain employees of the consumer, based on status, authority, and the like. In contrast, system 100 permits storage of such items by the consumer, immediately proximate and within a same perimeter 102, as the retail facility 104 location of their frequent purchases. Preferred embodiments, therefore, better serve such consumers and incentivize and improve their loyalty and return business with the owner/operator of facility 104. Numerous additional structural and methodology aspects in these regards are described in the remainder of this document, and are intended where appropriate to be within the inventive scope.

While FIG. 1 illustrates each rentable storage facility RSFx in parking group PG2, the inventive scope further contemplates alternative examples. For example, in FIG. 1, each group of four modules, forming a rentable storage facility RSFx, is positioned atop and centered existing parking lines (e.g., painted) in parking lot PL, that is, occupying space indicated originally as parking spaces. However, alternatively, module placement may be adjusted toward one end or the other of such parking spaces. Moreover, any one or more of rentable storage facilities RSF1 through RSF4 may be located in parking lot PL at other locations, and not necessarily over spaces indicated for parking. For example, in the orientation of FIG. 1, such facilities may be closer to the CONTRACTOR space so as to accommodate the typical consumer associated therewith. Alternatively, such facilities may be located away from general consumer parking, such as behind (i.e., top of drawing in FIG. 1) retail facility 104 while still within perimeter 102, for example for reasons of safety, aesthetics, or zoning requirements.

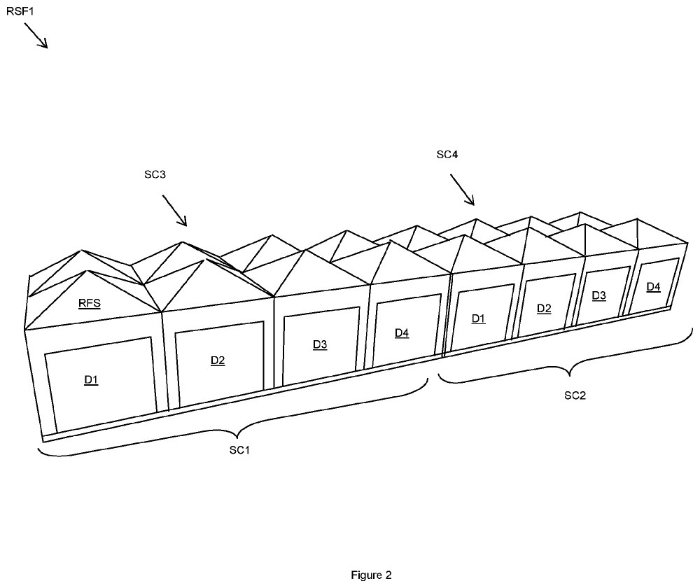

FIG. 2 illustrates a perspective view of a preferred embodiment implementation of rentable storage facility RSF1 from FIG. 1, with it understood that a comparable structure also may be implemented for any of rentable storage facilities RSF2 through RS4. In a preferred embodiment, each rentable storage facility RSFx is formed from a number of structurally self-supporting modules, which in one preferred embodiment may be implemented as commercial shipping containers, which are further modified as described herein. Shipping containers provide various benefits, for example due to their standardized sizing and load bearing capabilities, as well as a large surplus of such containers (e.g., in the United States), so that modifying and implementation of such containers as described herein provides various benefits, including the ecological advantages of removing surplus from potential unused and unsightly fields of containers, as well as simplicity in constructing a structure without the energy, labor, and other resource costs that are common for various types of housing and storage facilities. In all events, therefore, in FIG. 2, four such shipping containers SC1 through SC4 are illustrated, where the perspective view illustrates one longitudinal side of each of containers SC1 and SC2, while on the backside of the view are located containers SC3 and SC4. One form of commercially available shipping container is known as a “High Cube Shipping Container” whose maximum outside dimensions can range between 8 feet and 8.5 feet wide by 53 feet long by 9.5 feet tall (e.g., nominally 8 foot wide by 40 foot long); other containers differ in one or more dimensions, such as some containers are 20 feet long and some containers are 8.5 feet tall. For the purposes of this document, however, SCx can also mean any shipping container. Note also that with a container example having a footprint of nominally 8×40 feet, then each shipping container covers 320 ft², and accordingly a group RSFx of four such containers covers less than approximately 1,300 square feet. Accordingly, in comparison to a parking lot that covers, for example, 260,000 square feet, the total space consumed by three rental storage facilities, each having four shipping containers, within perimeter 102, is relatively small. Of course, alternative preferred embodiments may include more or less containers per group, or numbers of groups.

In the illustrated preferred embodiment, shipping containers are spatially arranged along a common horizontal ground level (e.g., preferably, single level and not stacked; alternatively, could be stacked) to facilitate a mechanical coupling between containers as well as an efficient manner of spatial use within perimeter 102 and access by consumers thereto. For example, as illustrated in FIG. 2, one shipping container SC1 has a longitudinal sidewall (i.e., along its greater dimension, that is, its length) immediately adjacent and parallel with the longitudinal sidewall of a proximate shipping container SC3 (similar as between shipping container SC2 relative to shipping container SC4). Additionally or alternatively, one shipping container SC1 has an end wall immediately adjacent and parallel with the end wall sidewall of a proximate shipping container SC2 (similar as between shipping container SC3 relative to shipping container SC4). Additional preferred embodiment optional modifications to the shipping containers are further described below.

In a preferred embodiment, each shipping container SCx may be modified in part, from its original shipping-based form, at a fabrication facility location remote from system 100, such as offsite or outside of perimeter 102. Thus, disruption at or near facility 104 is substantially minimized, while still permitting the eventual addition of self-storage functionality within site perimeter 102. In the illustration of FIG. 2, note that each shipping container includes a number (e.g., four) of doors D1 through D4, where the doors are positioned along a same sidewall of the shipping container and face away from the outer perimeter defined by a group of the containers. Accordingly, preferably offsite from system 100, four corresponding and appropriately sized apertures, one for each respective door, are made (e.g., cut) into the sidewall, which is typically corrugated steel, of the shipping container. In the example illustrated, each such aperture is rectangular, with a dimension of approximately 8 feet wide by 7 feet tall, although note that door width can change, for example, based on the number of doors (and corresponding rentable units) in a single container. As detailed later, a respective one of doors D1 through D4 is then installed relative to each aperture, where in one preferred embodiment each door is a standard roll-up door, as may be modified as further detailed below.

Each of doors D1 through D4 provides access into the interior of the respective shipping container to which the doors are coupled (e.g., affixed). Thus, in a nominally 8×40 foot shipping container, there is 320 square feet for internal storage in a shipping container. In an example wherein four doors (D1 through D4) are provided, then in one preferred embodiment the interior of such a shipping container may be partitioned into four respective storage units, each corresponding to a respective one of doors D1 through D4; thus, if equally partitioned in available interior space, a single shipping container of nominally 320 square feet, divided into four partitions, provides a user of a single unit space therein a total of 80 square foot of storage space (i.e., 320 ft²/4 units=80 ft²/unit). In a preferred embodiment, the partitioning of each space in this manner is also achieved offsite from system 100, and may be implemented by locating interior partitioning walls approximately parallel to the endwalls of the shipping container (and thus between or substantially perpendicular to opposing sidewalls of the container), and positioned relative to the desired partitioning and to coincide with an area accessible by a respective door; thus, in the example of FIG. 2, three such walls may be located in the interior of a shipping container, a first between the areas behind respective doors D1 and D2, a second between the areas behind respective doors D2 and D3, and a third between the areas behind respective doors D3 and D4 (hence, number of partitioning walls equals number of storage spaces, minus one). Note also that in a preferred embodiment the interior partitioning walls may be movable or removable, so as to allow adjustability of interior storage space. For example, in the three-wall example provided above, the wall between the spaces behind doors D1 and D2 could be removed, thereby providing a total of 160 square footage of space to a renter, accessible by both doors D1 and D2. Also, while doors D1 through D4 are shown along a longitudinal sidewall of the shipping container, in alternative preferred embodiments an endwall also may include a door, providing an alternative direction of access, provided that door is facing outward when the shipping container is oriented relative to one or more containers in the group that forms the rentable storage facility RSFx.

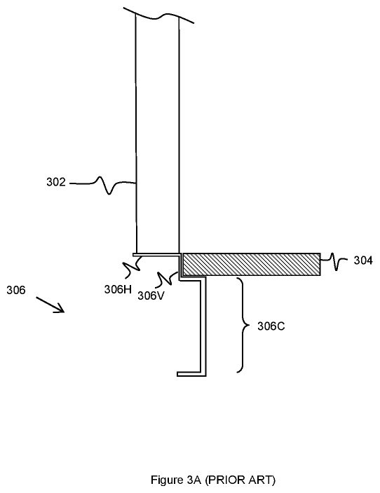

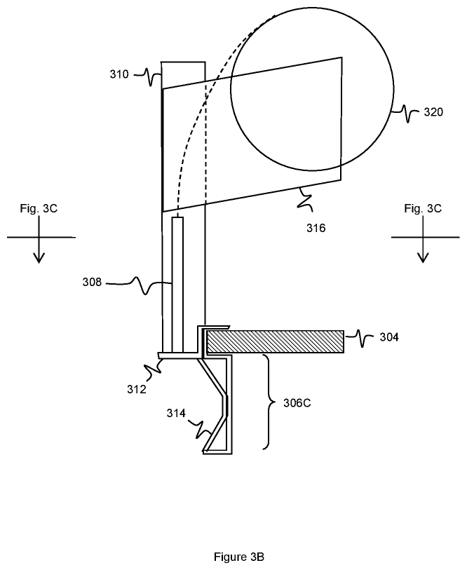

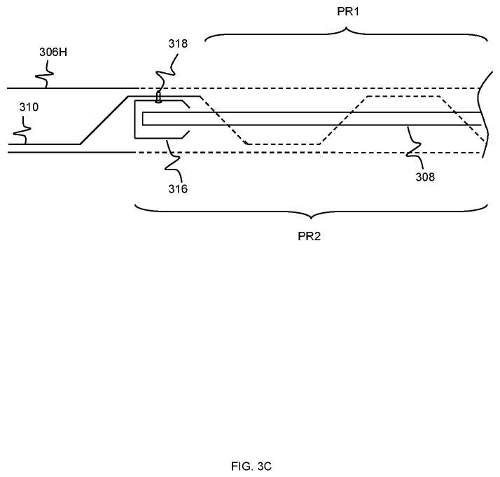

For comparison to a preferred embodiment aspect described later, FIG. 3A illustrates a side cross-sectional view of a prior art shipping container corrugated wall 302 relative to the container flooring 304. Beneath the bottom of wall 302 is located a lower rail 306 (could be container side or bottom rail), which has a horizontal portion 306H, from which a vertical portion 306V extends along an end of container flooring 304. Below vertical portion 306V is an outer-facing C-shaped portion 306C.

FIG. 3B illustrates a side cross-sectional view of a roll up door 308 installed in line with a cutaway wall 310 of a shipping container per a preferred embodiment. Starting from the general central bottom of FIG. 3B, note that the horizontal portion 306H from the prior art (FIG. 3A) is removed, and instead a rigid (e.g., metal) lower shelf 312 is positioned to abut the end and a portion of the top of container flooring 304. While not shown, lower shelf 312 may be affixed to flooring 304 with one or more fasteners, for example by screwing the inwardly-extending portion of shelf 312 to an upper surface of flooring 304. In any event, with the positioning of lower shelf 312, it provides a metal door seal a lower horizontal surface extending away from flooring 304 and for the bottom of roll up door 308 to contact when drawn downward, where shelf 312 includes a vertical portion aligning with the vertical edge of (e.g., the plywood) flooring 304. Note the upper horizontal surface of shelf 312 may overlaps, and extend in the interior direction of, a portion (e.g., 2 to 3 inches) of the upper surface of the plywood floor, to which the door seal member may be affixed, again such as by fastener and/or adhesive. Given this arrangement, upon closing door 308 downward, the bottom of the door descends below the upper surface of the flooring 304 (e.g., plywood) inside the shipping container to contact the lower horizontal surface of the shelf 312, thereby preventing rainwater from entering the unit and potentially damaging interior contents. Optionally, additional flashing 314 may be added below shelf 312, and on the remaining portion of outer-facing C-shaped portion 306C.

FIG. 3B also illustrates a roll up door mounting bracket 316, preferably connected to the outer surface (i.e., aperture facing) of where corrugated wall 310 is cut away to accommodate door 308. A portion of FIG. 3B is also shown in a cutaway top-down plan view in FIG. 3C. In these figures, therefore, one skilled in the art will understand that a first portion PR1 of wall 310 is cut away (shown by dashes in the corrugation in FIG. 3C) to provide an aperture for a doorway, and bracket 316 is attached to portion PR1, such as by one or more screws/fasteners 318. Bracket 316 can provide side support and upward rollaway support (including a head coil 320) assisting the movement of door 308 up and down adjacent the cutaway portion (i.e., in the aperture formed from the cutaway) of wall 310. Further, note that to the sides of door 308, the prior art horizontal portion 306H remains, but it is cut away along a second portion PR2 (also shown in dashed lines), where shelf 312 (see FIG. 3B) may be positioned.

Also preferably distant from system 100, surface aesthetics are improved on each container, as compared to that visible in the original form for such containers, such as when such containers are used to originally ship goods from abroad. Surface and aesthetic improvements may be in various forms of a facade, for example, may include painting the container exterior sidewalls or covering or attaching thereto cladding, metal flashing, trim, or other finish. Indeed, FIG. 3B illustrates a portion of such flashing 314 attached to the exterior facing side of the container bottom rail. Note also that such surface facade additions need not be included on areas that will not be outward facing on the shipping container when grouped with one or more other containers; thus, in FIG. 2, for example, with respect to the orientation and perspective shown therein, the front and left facing walls of shipping container SC1 may include a facade treatment, while the rear and right facing walls do not, as those latter walls will abut other containers in the group, and therefore be unviewable from an exterior perspective relative to the group as a whole. Indeed, therefore, at least one sidewall (or endwall) may be unfinished for most implementations while the other is finished with some type of facade, as it is preferable that at least one sidewall (or endwall) will abut the sidewall (or endwall) of another container in the group (unless a group is created with only end-to-end orientations of the containers).

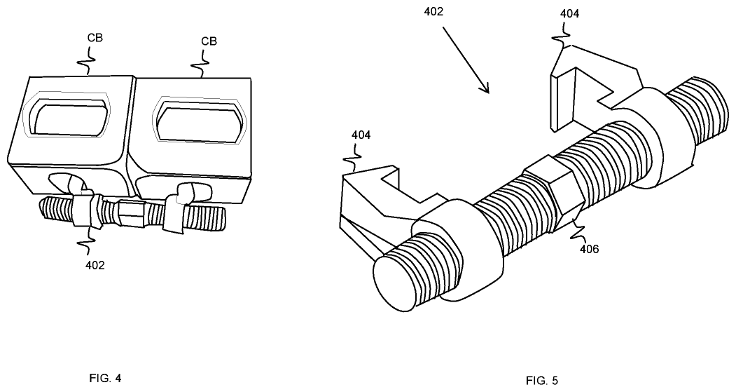

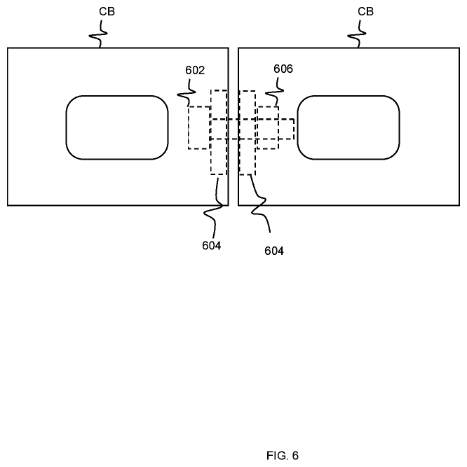

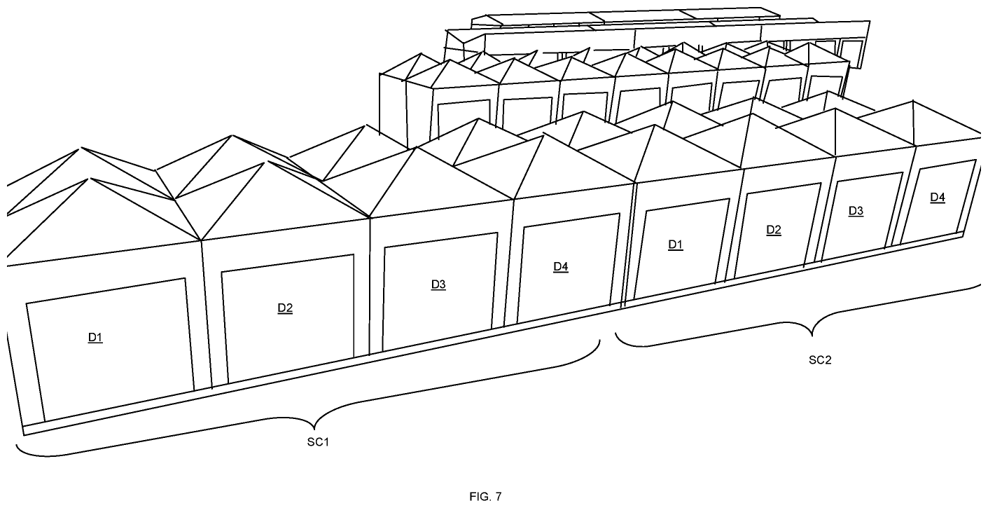

Once each shipping container is modified as described above, it is transported to a location at which a system 100 may be created, for example, to the parking area proximate or otherwise within a land area perimeter of a retail establishment. In a preferred embodiment, such transportation may be by a tilt trailer, operable to transport the container along a bed that is substantially horizontal during transport, but which may be actuated at its destination (e.g., via hydraulics) to tilt and thereby urge or advance the container off the trailer and onto a position atop the surface of the parking lot PL at system 100. Note that once the container is on parking lot PL, a localized mechanical device (e.g., winch, come-along, or the like) may be used for additional shorter-distance movements or positional refinements of a container, for example, urging into abutment or proximity with another container. Thus, larger or heavy construction equipment, such as cranes, are not needed within perimeter 102 to implement rentable storage facilities RSFx. In a preferred embodiment, non-rusting members (e.g., shims) are positioned between the lower contact surface of each shipping container and parking lot PL. In this regard, commercial shipping containers include block structures at the bottom (and top) of each of the container's four corner posts, typically affixed by welding, where such structures are sometimes referred to as corner blocks CB or corner castings; indeed, in traditional shipping use of such containers, they are stacked atop one another, for example with each of the upper corner blocks of a first container aligned and in contact with a respective lower corner block of a second container that is atop, and thereby load-supported by, the first container. In the preferred embodiment, however, a non-rusting member is positioned between each lower corner block CB of a container and the parking surface, so as to reduce the chance of surface staining or marring in parking lot PL and also to permit elevation adjustment so that the container is oriented at a same elevation as any proximate container(s). Further, as described above in connection with FIG. 2, each container is preferably positioned adjacent to at least one more container in a group, in either side-by-side or end-to-end orientation, and whereby a pair of the corner blocks of one such adjacent container are immediately proximate (e.g., an inch or less) or in direct contact with a pair of corner blocks of the other adjacent container. Further in this regard, FIG. 4 illustrates a pair of corner blocks, and for simplification the blocks are shown apart from respective containers, with it understood that the illustration is to be achieved with one container proximate another, by securely fastening the containers to one another by joining together a respective corner block of each such container. Thus, the preferred embodiment further contemplates a corner joining (or clamping) apparatus 402 for affixing the corner blocks relative to one another, where FIG. 4 illustrates as such apparatus a bridge-fitting, also shown in FIG. 5 apart from corner blocks. In a preferred embodiment, the bridge-fitting includes a threaded member that is threadably mated into receiving threads on two different hooks 404, each preferably facing inwardly. Thus, as shown in FIG. 4, each hook 404 is preferably located through a respective aperture in a respective corner block, and then the threaded member is rotated, for example by a hexagonal portion 406 on the threaded member, so as to draw the hooks 404 toward one another. Hence, the rotational movement of the threaded member creates a translational linear clamping force between the two hooks 404, thereby drawing the two corner blocks CB in contact with another. At system 100, therefore, the bridge-fitting or comparably functional corner joining apparatus is preferably implemented between respective upper corner blocks of two adjacent shipping containers, thereby drawing the containers together, in alignment, and as an impediment to an accidental or nefarious effort to separate one container from the group to which it is attached. Note further that the illustrated bridge fitting is just one example of container-to-container (e.g., corner block to corner block) attachment, and alternatives are contemplated. For example, FIG. 6 illustrates an alternative fastener for use within the interior of two adjacent corner blocks CB, and comprising a threaded machine bolt 602, a respective washer (or plate) 604 against the interior surface wall of the block, and a nut 606 on the distal end of the bolt. Still others may be ascertained by one skilled in the art.

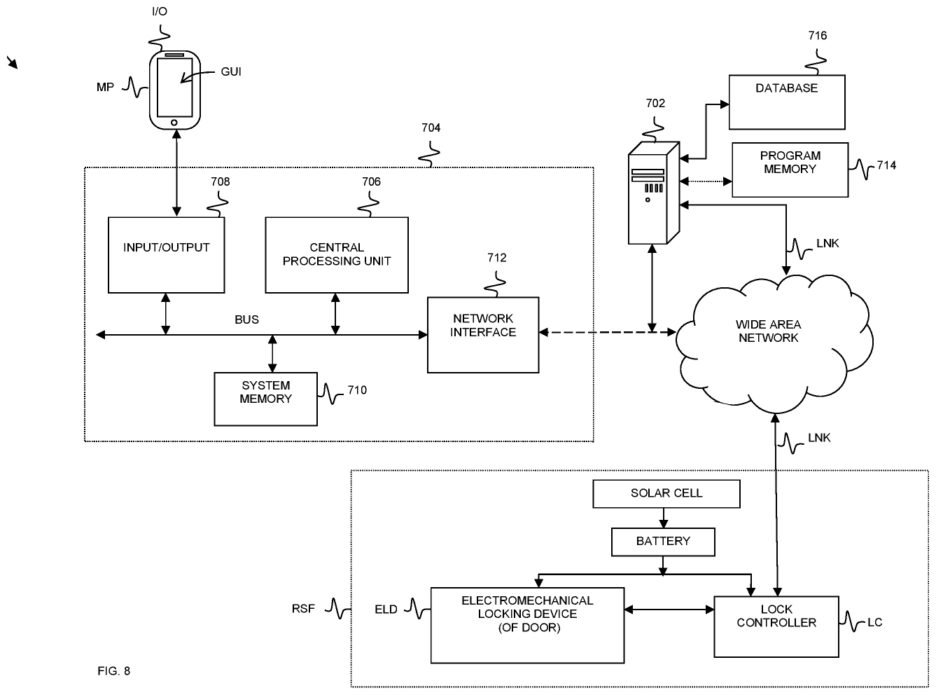

Once the containers in a group are positioned within perimeter 102, and preferably affixed via a corner joining apparatus as described above, then preferably at the site of system 100 a cover is provided above the corner blocks so joined, so as to conceal the corner joining apparatus and to reduce third party access thereto. In a preferred embodiment, this cover is incorporated into a roof structure RFS for the entire container. By way of example, FIG. 2 illustrates each container having a roof structure RFS (or plural roofs) of a right pyramid shape with a base and four sides, with each pyramid corresponding to a single storage door, and the rentable storage space accessible on the interior of the shipping container as accessible through that door. Such a roof may be constructed, for example, also of corrugated (or sheet) metal, or of other appropriate materials, and preferably includes some level of non-horizontal incline for drainage and other debris directing purposes. Alternative roof orientations are also contemplated, for example as shown in FIG. 7, such as having a cross-sectional shape, in the direction of the longitudinal major axis of the container (i.e., down its longest length, nominally 20 or 40 feet) of a trapezoid or triangle. The added structure RFS can double as advertisement area and could be leased to suppliers of those expected to rent storage space in the containers (e.g., tool manufacturers; material suppliers), generating additional revenue. The facility also is designed with adequate ventilation to avoid condensation.

In a preferred embodiment, also related to door installation is the provision of one or more lock mechanisms, so that a user (e.g., renter) of the space associated with the door can lock and unlock the door, so as to protect the user's goods from others. One such lock mechanism is an electromechanical locking device, such as having a pin, gear, or other movable member(s) that is engaged/disengaged (e.g., via a solenoid) so as to respectively lock/unlock (or vice versa) the door. Further contemplated with an electromechanical locking device is an electronic controller, either with each locking device, container, or centralized among a group of such containers, and that electrically communicates, either via direct wiring or wirelessly, with the locking/locking function of each electromechanical locking device. Accordingly, various preferred embodiment alternatives are provided so that the user may operate the electromechanical locking device, as further explored below.

In one preferred embodiment, located at each rentable storage facility RSFx is a lock controller LC as shown in FIG. 8, which includes a system 700 for communicating with, and operating, an electromechanical locking device ELD of a storage container door. Lock controller LC and locking device ELD are connected to a power supply, preferably provided by a battery located at the site of the container (i.e., either per container or per container group) and that is charged via a photovoltaic (solar) cell, thereby eliminating the need to provide additional power cabling associated with the installation of each rentable storage facility. Also contemplated are one or more low power (e.g., LED) lights affixed to, or relative to, each shipping container or rentable storage facility RSFx, which also may be powered by the battery. Lock controller LC, and hence locking device ELD by virtue of its communications with lock controller LC, also may communicate, preferably wirelessly (or could be via wire) with a network link LNK to a wide area network, such as a cellular network and/or the Internet, so that each electromechanical locking device may be locked or unlocked under control of a remote device, such as an electronic hosting computer 702 or the like that also is able to communicate across a network link LNK. In this regard, the preferred embodiment further may include software, such as a web-based platform, and in communication with other computing devices, whether stationary (e.g., work stations, desktops) or portable (e.g., laptops, tablets, mobile phones, smart devices, etc.), where FIG. 8 illustrates a mobile phone MP as an example. As known in the art, such computing devices typically include various input/output (I/O) mechanisms, including a screen and/or buttons, microphone, speaker, local and distant wireless communications, and the like. In the present inventive scope, a user thusly interacts, via such features, and in connection with software executed on mobile phone MP, to control the locking device ELD of the customer's rentable unit door. Such software includes a graphical user interface (GUI) that facilitates this aspect, and may include additional aspects in various preferred embodiments. For example, the software may be a mobile phone application (so-called “app”) on mobile phone MP and that has numerous features accessible to a user. For example, such an app may include a registration link or web URL address, whereby a user initially is provided a storage unit rental agreement to review and, if accepted by the user, to rent a storage unit at system 100, for a period of time (e.g., monthly, quarterly, annually). Thus, the GUI will identify the location of system 100 (e.g., by address or other geographic indicator, such as map indication or in response to GPS positioning of the user's location, if the user is at or nearby the location of the storage unit he/she desires to rent) as well as the availability of a rentable unit(s) at that location. The user then may see unit availability and, if the user desires, the user submits sufficient identifying information to qualify for rental, electronically signs a user agreement, including accepting possible terms and conditions thereto (e.g., pricing, usage limitations, and the like), and provides a manner of payment, via, for example, a commercial backend or other interface associated with the GUI. A preferred embodiment also preferably provides the user a confirmation copy, such as via email, of the completed and executed user agreement. A preferred embodiment also may offer, or mandate, a purchase of insurance in association with the contents to be stored in the user's rented unit.

Once the above-described user information is completed and verified, the GUI further provides the user the ability to lock/unlock its unit, such as via an on-screen lock/unlock “button” or the like. Thus, when the user touches or activates the “unlock” feature in the software, the software communicates to lock controller LC associated with the container in which the user's storage unit is located, and in response lock controller LC actuates the electromechanical locking device ELD at the door of the user's unit, so as to unlock that door. The user then has an unlocked unit, can open the door thereto, and store and/or retrieve contents inside the storage unit (i.e., in the unit interior, beyond the unlocked door). Once the user is done accessing that storage area and is ready to lock the unit, the user can again use the software to activate a “lock” feature displayed by the software GUI, which again causes communication to the lock controller LC at the container and appropriate unit and engages the electromechanical locking device ELD at the door of the user's unit. In an alternative preferred embodiment, the user also may be provided a manner of mechanically locking his/her unit, such as by turning of a locking mechanism or use of one's own private lock, so as to not require an additional electronic or software access for the locking aspect or to provide redundancy to the electromechanical locking device LED. Also in this regard, in a preferred embodiment a sensor is associated with the electromechanical lock and/or the door and/or incorporated in lock controller LC, so as to determine if/when the door is locked, unlocked, closed, or open, as such information also may be communicated by lock controller LC to network link LNK and hosting computer 702, for example, for purposes of data logging, security and also to inform the renter of when these conditions occurred or are occurring, by real time or periodic reports or alarms, either via the app or separate communications, such as text or email, as set by either the user or the administrator of hosting computer 702. Additional reporting to the user is also contemplated, such as current payment status and remaining lease term. Lastly, note further that the remote control afforded by a preferred embodiment also permits an administrator of the system comparable information and control. Accordingly, the administrator may facilitate timely rental of storage facilities based on availability information, and may control a user's access to a unit if the user become non-compliant with its terms and conditions—for example, in an instance of uncured delinquent payment, the user's access to unlock its unit may be denied. The remaining elements of FIG. 8 should be understood to one skilled in the art, and are intended to be illustrative but not all necessary in all implementations, and such a person can make various alterations based on technology and other considerations. The following discussion, therefore, is only by way of example.

System 700 performs the operations described in this document to efficiently permit a user to enroll in an agreement to rent a storage unit and to operate an electromechanical locking device ELD with a computing system 704 (e.g., mobile phone MP), and also as noted above potentially to receive other related communications. In this example, system 700 may be realized by way of a computing system 704 connected to, or otherwise coupled to communicate with, hosting computer 702 (e.g., a server) by way of a network, where the network may be one of various networks, including a wide area network such as the global Internet. In this sense, therefore, computing system 704 may be a user device (e.g., mobile phone MP) which communicates with the Internet, and where hosting computer 702 and its related architecture and software are hosted on a website, as may be operated by a self-storage management company, retailer, or the like. Thus, such a website may allow numerous users, such as by hosting a different account for each respective user. As will be evident, therefore, the preferred embodiment permits an individual, such as an ordinary household do-it-yourself consumer, or a commercial contractor, to use their private computing system 704 such as a mobile phone MP, providing access to a rentable storage unit within system 100, that is, proximate a retail facility 104, via a website (more particularly, via their account accessible via the website). Of course, the particular architecture and construction of a computer system useful in connection with the preferred embodiments may vary widely. For example, computing system 700 may be realized by a single personal computing device, including a smart phone or tablet, or a physical computer, such as a conventional workstation, personal computer, or alternatively by a computer system implemented in a distributed manner over multiple physical computers. Accordingly, the generalized architecture illustrated in FIG. 8 is provided merely by way of example.

As shown in FIG. 8 and as mentioned above, system 700 includes computing system 704 and hosting computer 702. Computing system 704 includes a central processing unit 706, coupled to a system bus BUS. Also coupled to system bus BUS is an input/output (I/O) interface 708, which communicates with peripheral I/O functions by which a user may input or receive information provided to or from computing system 704, such as via a keyboard, display, a camera (e.g., for code scanning, where in a preferred embodiment each rentable unit has a code, such as QR code, located thereon), microphone, speaker, buttons, touch screen, printer or printer communications, etc. Central processing unit 706 refers to the data processing capability of computing system 704, and as such may be implemented by one or more CPU cores, co-processing circuitry, and the like. The particular construction and capability of central processing unit 706 is selected according to the application needs of computing system 704, such needs including, at a minimum, the carrying out of the functions described in this document, and also including such other functions as may be executed by system 704. In the architecture of system 704 according to this example, a system memory 710 is coupled to system bus BUS, and provides memory resources of the desired type useful as data memory for storing input data and the results of processing executed by central processing unit 706, as well as program memory for storing the computer instructions to be executed by central processing unit 706 in carrying out those functions. Of course, this memory arrangement is only an example, it being understood that system memory 710 can implement such data memory and program memory in separate physical memory resources, or distributed in whole or in part outside of computing system 704.

Computing system 704 also includes a network interface 712 that is conventional in nature of an interface or adapter by way of which computing system 704 accesses network resources on a network. Inasmuch as system 704 may be a portable device, interface 712 may include various types of radio communication apparatus, including cell communications, WiFi, Bluetooth, and other known or ascertainable communication protocols and standards. In all events, interface 712 provides system 704 access to network resources, which include hosting computer 702 which also may be accessible on a smaller (e.g., local area) network, or a wide-area network such as an intranet, a virtual private network, or over the Internet; hence, via those arrangements, various wired and wireless communications may be achieved. In this embodiment, hosting computer 702 is a computer system, of a conventional architecture, and as such includes one or more central processing units, system buses, and memory resources, network interface functions, and the like. According to a preferred embodiment, hosting computer 702 includes a program memory 714, which is a computer-readable medium that stores executable computer program instructions, according to which the operations described in this document are executed and so as to communicate information to, and receive information from, computing system 704. In a preferred embodiment, these computer program instructions are executed by hosting computer 702, for example in the form of an interactive application, upon input data communicated from computing system 704, to create an interactive system 700 by which a user of system 704 may browse, consider, rent, control the door of, and receive post-rental information about, a rentable storage facility unit or units at facility system 100. Further in this regard, a database 716 is part of, or accessible by, hosting computer 702, so as to provide data relating to rentable storage units, including lock/unlock and other pertinent information, preferably at one or more rentable storage facilities, and indeed potentially across dozens if not hundreds or thousands of different geographic locations.

The particular memory resource or location at which the user and rentable storage unit information and control, and user-preferences and selections, database 716, and program memory 714 physically reside can be implemented in various locations accessible to system 700. For example, these data and program instructions may be stored in local memory resources 710 within system 704, within hosting computer 702, program memory 714, database 716, or in network-accessible memory resources to these functions. In addition, each of these data and program memory resources can itself be distributed among multiple locations, as known in the art. It is contemplated that those skilled in the art will be readily able to implement the storage and retrieval of the applicable data, computations, and other information useful in connection with the preferred embodiment, in a suitable manner for each particular application.

According to a preferred embodiment, by way of example, system memory 710 and program memory 714 store computer instructions executable by central processing unit 706 and hosting computer 702, respectively, to carry out the functions described in this document. These computer instructions may be in the form of one or more executable programs, or in the form of source code or higher-level code from which one or more executable programs are derived, assembled, interpreted, or compiled. Any one of a number of computer languages or protocols may be used, depending on the manner in which the desired operations are to be carried out. For example, these computer instructions for creating the model according to preferred embodiments may be written in a conventional high level language, either as a conventional linear computer program or arranged for execution in an object-oriented manner, or in numerous other alternatives including those well-suited for web-based or web-inclusive applications. These instructions also may be embedded within a higher-level application. In any case, it is contemplated that those skilled in the art having reference to this description will be readily able to realize, without undue experimentation, the preferred embodiments in a suitable manner for the desired functionality. These executable computer programs for carrying out preferred embodiments may be installed as resident within system 704 as described above, or alternatively may be in the form of an executable web-based application that is accessible to hosting computer 702 and communicable in part or whole to system 704 for receiving inputs from the user, executing algorithms modules at a web server, and providing output to the user at some convenient display or in printed form. Alternatively, these computer-executable software instructions may be resident elsewhere on the local area network or wide area network, or downloadable from higher-level servers or locations, by way of encoded information on an electromagnetic carrier signal via some network interface or input/output device. The computer-executable software instructions originally may have been stored on a removable or other non-volatile computer-readable storage medium (e.g., a DVD disk, flash memory, thumb drive, card, or the like), or downloadable as encoded information on an electromagnetic carrier signal, in the form of a software package from which the computer-executable software instructions were installed by system 704 in the conventional manner for software installation.

Given the preceding, also noteworthy in connection with preferred embodiments is that a rentable storage facility, within a common premise to a retail facility 104 as shown in FIG. 1, may be implemented on-site within a very reasonable time frame, particularly as compared to traditional construction of self-storage facilities. Indeed, with a preferred embodiment aspect of modifying containers off-site as described above, it is contemplated that such modified containers may be brought to system 100, properly positioned, physically attached to one another (see, e.g., FIGS. 4 and 5), electronically and electrically coupled if sharing a common controller and/or power source, all within less than a week, and preferably within two days if not a single 24 hour period. Thus, potentially within a single day, a rentable facility may be located at a common retail site, and with system 700 may be available for rent/usage by consumers immediately or shortly thereafter (e.g., within 48 hours). Moreover, such implementation and access may be done with minimal involvement by the proprietor of the retail space. Still further, note that the construction described herein also facilitates expeditious removal/relation of any one or more of rental storage facilities, if desired. Accordingly, various preferred embodiments provide numerous improvements over the prior at, some mentioned above and/or summarized below:
Flexible timing for widespread dissemination. Within a few months, supply of rentable storage facilities may be provided to retail spaces, commencing if desired with a trial period and eventually implementing at a large majority of all stores, with an expectation of expeditious returns on consumer rental revenue, loyalty, and repeat purchases from retail facility 104, proximate the rentable storage facility.
Quick Installation. Installation on a per site basis is relatively fast and requires no added concrete, structural steel, utilities (electricity, water, gas, cable, telephone, etc.), detention or fire lanes.
Transportable. If required, a rental storage facility can be removed from one rental site and relocated to another, potentially within 24 to 48 hours.
Environmentally Friendly. Each rentable self-storage facility is environmentally friendly. No new steel or concrete is needed to build a facility. The production and manufacture of traditionally built self-storage facilities consumes electricity, and a byproduct of concrete production is CO2 (a greenhouse gas believed to damage the earth's ozone layer). Using shipping containers for this storage proposal instead of building via traditional methods is estimated by some to save enough electricity to power 1.4 households for one year for every shipping container used. Plus, upcycling a shipping container eliminates the need to recycle its steel, a high energy consuming process. Lastly, each facility is solar powered, an environmentally friendly process.

Further, while the inventive scope has been demonstrated by certain preferred embodiments, one skilled in the art will appreciate that it is further subject to various modifications, substitutions, or alterations, without departing from that inventive scope. Thus, the inventive scope is demonstrated by the teachings herein and is further guided by the exemplary but non-exhaustive claims.

1. A common premise facility system, comprising:
an area of land consisting of ten acres or less;
a retail facility on the area of land;
a rentable storage facility comprising a plurality of shipping containers on the area of land and external from the retail facility; and
wherein each shipping container in the plurality of shipping containers comprises a plurality of doors for accessing respective rentable storage units within a shipping container.

2. The common premise facility of claim 1 and further comprising joining apparatus for coupling each shipping container in the plurality of shipping containers to at least one other shipping container in the plurality of shipping containers.

3. The common premise facility of claim 1 and further comprising:
an electromechanical lock associated with each door in the plurality of doors; and
a controller for permitting remote control of the electromechanical lock for selectively unlocking a door associated with the electromechanical lock.

4. The common premise facility of claim 3:
wherein the controller comprises a communications interface for communicating with a network; and
wherein the controller is responsive to a communication from the network for selectively unlocking a door associated with an electromechanical lock.

5. The common premise facility of claim 1 and further comprising a parking area for use by consumers of the retail facility, and wherein the plurality of shipping containers is located within the parking area.

6. The common premise facility of claim 1 wherein each shipping container in the plurality of shipping containers comprises a floor; and
further comprising apparatus for offsetting a bottom of each door in the plurality of containers such that when each door is closed, a lower edge of the door descends below an upper surface of the floor of the container.

7. A method of operating a computing system to control access in connection with a rentable storage facility unit, comprising the steps of:
enrolling a rentable unit user via an electronic interface to the computing system;
providing a user interface to the user via the computing system;
receiving, at the computing system, from the user, in response to the user interacting with the user interface, a request to unlock a door for accessing an interior of a rentable storage facility unit; and
responsive to the request, and via the computing system, operating a door lock associated with a selected door coupled to a shipping container, the shipping container partitioned into multiple interior storage units and having multiple doors, for unlocking the selected door for providing the user access to a selected interior storage unit of the multiple interior storage units.

8. A method of installing a rentable storage facility proximate a retail facility, and within a perimeter that encloses the retail facility and the rentable storage facility in an area of land consisting of ten acres or less, the method comprising:
at a location outside the perimeter, coupling a plurality of doors to each shipping container in a plurality of shipping containers, each door in the plurality of doors for accessing rentable storage unit within the shipping container;
positioning the plurality of shipping containers within the perimeter; and
within the perimeter, coupling each shipping container in the plurality of shipping containers to at least one other shipping container in the plurality of shipping containers.

9. The method of claim 8 wherein the positioning and coupling steps collectively occur in a time period less than 48 hours.

10. The method of claim 8 wherein each shipping container comprises two endwalls and two sidewalls, and further comprising, at a location outside the perimeter, coupling a facade to at least one endwall and at least one sidewall.

11. The method of claim 8 wherein each shipping container comprises two endwalls and two sidewalls, and further comprising, at a location outside the perimeter, coupling a facade to at least one endwall and at least one sidewall and leaving at least one sidewall unfinished.

12. The method of claim 8 and further comprising, within the perimeter, coupling a roof structure to the plurality of shipping containers.

13. (canceled)

14. (canceled)

15. (canceled)

16. (canceled)

17. (canceled)

18. The common premise facility of claim 1 wherein each of the respective rentable storage units within a shipping container is separate by a wall from any other rentable storage unit within the shipping container.

19. The common premise facility of claim 1 wherein the area of land consists of ten acres or less.
